(19) United States
(12) Patent Application Publication
(10) Pub. No.: US 2024/0039466 A1
(43) Pub. Date: Feb. 1, 2024

(54) SOLAR ARRAY

(71) Applicant: Roberto Albertella, Biel/Bienne (CH)

(72) Inventor: Roberto Albertella, Biel/Bienne (CH)

(21) Appl. No.: 18/132,159

(22) Filed: Apr. 7, 2023

Related U.S. Application Data
(60) Provisional application No. 63/329,025, filed on Apr. 8, 2022.
(60) Provisional application No. 63/430,159, filed on Dec. 5, 2022.

(51) Int. Cl. H02S 30/20

(52) U.S. Cl. CPC H02S 30/20

(57) ABSTRACT

A solar array system. The system includes a plurality of foldable solar panels. At least some of the panels can be folder onto other panels by a drive mechanism under the control of a control unit. The control unit responds to environmental conditions, such as weather and time of day, and controls the drive mechanism to fold and unfold selected panels based on such conditions.

### CROSS-REFERENCE TO RELATED APPLICATIONS

This application claims priority to Patent Application Ser. No. 63/329,025 filed Apr. 8, 2022, and entitled “Prefabricated Solar Panel Array” and Patent Application Ser. No. 63/430,159 filed Dec. 5, 2022 and entitled “A Solar Array”, both applications being incorporated herein by reference.

### TECHNICAL FIELD

The present invention generally relates to the field of renewal energy and more particularly, is directed to a solar array having a plurality of solar panels that can be folded onto themselves for storage and transport and then be unfolded at a site of interest when needed to generate electrical energy. A plurality of solar arrays can be connected together in order to generate the desired amount of electrical energy.

### BACKGROUND OF THE INVENTION

The law of conservation of energy holds that energy cannot be created or destroyed, but rather can only be converted from one form to another. This law is implemented in the present invention by converting the energy contained in sunlight to electrical energy.

As known in the art, electrical energy can be generated in a number of ways. One such way is by converting the chemical energy stored in fossil fuels, such as coal and petroleum, into heat. The heat is then used to boil water to produce kinetic energy in the form of steam which drives an electric generator.

The energy of a stored body of water, such as water behind a dam, can also be released in a controlled way in order to also turn the blades of an electric generator.

Generating electrical energy in the manner described above can produce large amounts of energy at a relatively low cost per kilowatt hour. Doing so however, requires a large and expensive infrastructure. Such an infrastructure is not suitable or practical for localized and small quantity energy generation needs.

Energy generation using various chemical processes are also know in the art. Examples of such processes include batteries and fuel cells. While chemical process based electrical energy production is often convenient, such processes suffer from limited power capability, high cost compared to power produced and sustainability issues.

An unfortunate by product of many current energy generation methods is the adverse effects on the environments and air pollution. Scholars have noted that the traditional approaches to generating electrical energy accounts for 66 percent of the sulfur dioxide in the environment, 25 percent of the nitrogen oxides, higher levels of ground level ozone (smog) and carbon dioxide. All of these elevated phenomena negatively affect the environment and the overall health and safety of society.

Thus, in recent years there has been a move toward renewable sources of energy. Renewable energy refers to natural resource that replenish themselves over time without depleting other resources.

The present invention takes advantages of the benefits of sunlight as a renewable energy source by providing an improved solar array.

The installation of traditional of solar panel arrays takes a long time, which complicates their use for temporary electrification projects. Conventional prefabricated systems use traditional solar panels and therefore require the use of more metal, making them heavier and more expensive.

These problems are solved by the present invention which is directed to a prefabricated solar array that can be compacted for easy storage and transport and then be opened at a desirable location when needed to generate electrical energy.

### SUMMARY OF THE PRESENT INVENTION

As stated above, the installation of solar panels takes a long time, which complicates their use for temporary electrification projects. The present invention solves this problem.

As described herein, the present invention enables the pre-assembly and pre-wiring of solar panels on a collapsible metal structure that is easy to transport and deploy by unskilled users and reduces the tasks to be performed in the field.

The invention differs from what currently exists. This invention allows the prefabrication of very light and compact solar panel arrays, saving shipping and handling costs.

The invention is an improvement on what currently exists and allows for the prefabrication of very light solar panel arrays, which saves transportation, installation, and handling costs. The excessive weight and handling difficulties of the existing systems make it difficult to operate them in the short term because the costs they generate jeopardize the profitability of any temporary electrification project.

With lower manufacturing costs and less weight, the present invention makes short- and medium-term temporary electrification projects cost effective.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is an elevational view of one embodiment of a central frame of the solar array of the present invention;

FIG. 2 is an elevational view of one embodiment of a side frame of the solar array of the present invention;

FIG. 3 illustrates the construction of one embodiment of the locking handles of the solar array of the present invention;

FIG. 4 illustrates the construction of the one embodiment of the hinges used in the solar array of the present invention;

FIG. 5 is a top view of one embodiment of a solar array in accordance with the present invention;

FIG. 6 is an elevational view of one embodiment of stacked solar panels in accordance with the present invention;

FIG. 7 is an elevational view of another embodiment of a solar array in accordance with the present invention;

FIG. 8 is an electrical block diagram showing a plurality of solar arrays connected in serials in accordance with the present invention;

FIG. 9 is an electrical block diagram showing a plurality of solar arrays connected in parallel in accordance with the present invention;

FIG. 10 is an electrical block diagram showing one embodiment of a solar array in accordance with the present invention;

FIG. 11 is an electrical block diagram showing another embodiment of a solar array in accordance with the present invention;

FIG. 12 is an electrical block diagram showing one embodiment of the control unit for a solar array in accordance with the present invention;

FIGS. 13-15 depicts another embodiment of a solar array using two drivers in accordance with the present invention;

FIGS. 16-19 depicts an exploded view of the embodiment illustrated in FIGS. 13-15;

FIG. 20 depicts a lateral view of the closed segment (0°) of the embodiment of the present invention as shown in FIGS. 13-15;

FIG. 21 depicts a side view of the segment in a flat position (180°) of the embodiment of the present invention as shown in FIGS. 13-15;

FIG. 22 depicts a side view of a segment at its maximum opening of 240° of the embodiment of the present invention as shown in FIGS. 13-15;

FIG. 23 depicts two segments in the assembly phase of the embodiment of the present invention as shown in FIGS. 13-15;

FIG. 24 depicts a complete solar array in accordance with the embodiment of the present invention as shown in FIGS. 13-15; and

FIGS. 25-27 depicts 10 solar arrays in accordance with the embodiment of the present invention as shown in FIGS. 13-15 stacked on a pallet.

### DESCRIPTION OF THE PREFERRED EMBODIMENT

A preferred embodiment of the present invention will now be described with reference to the accompanying drawings.

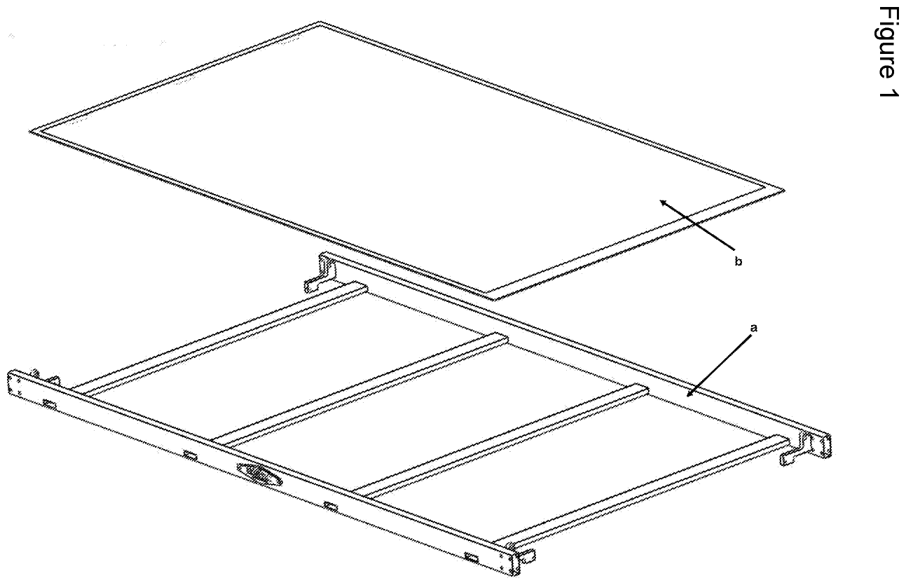

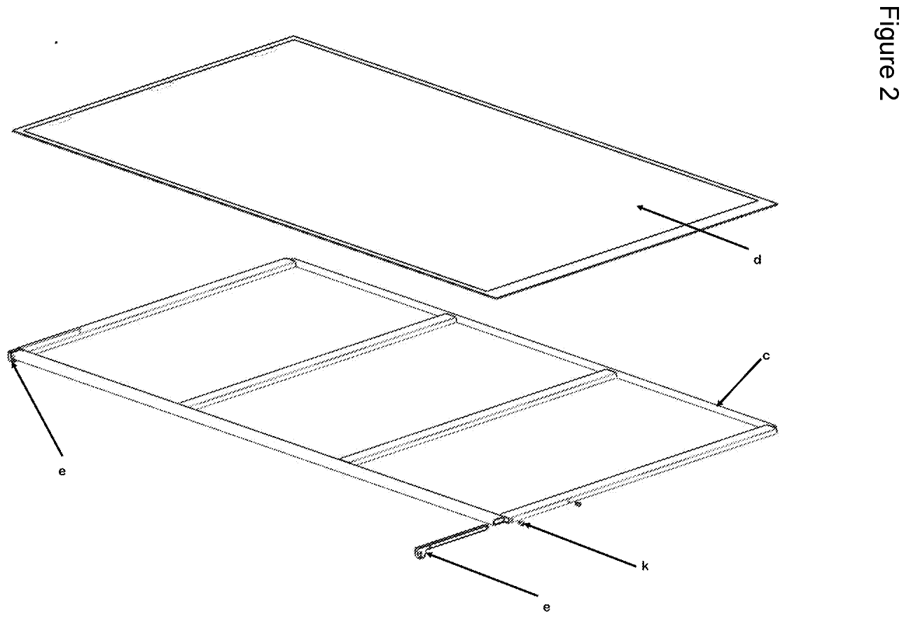

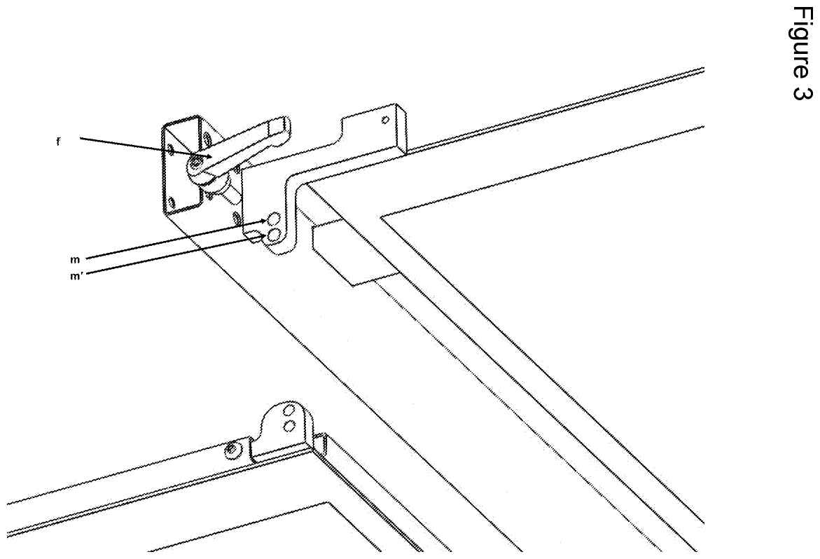

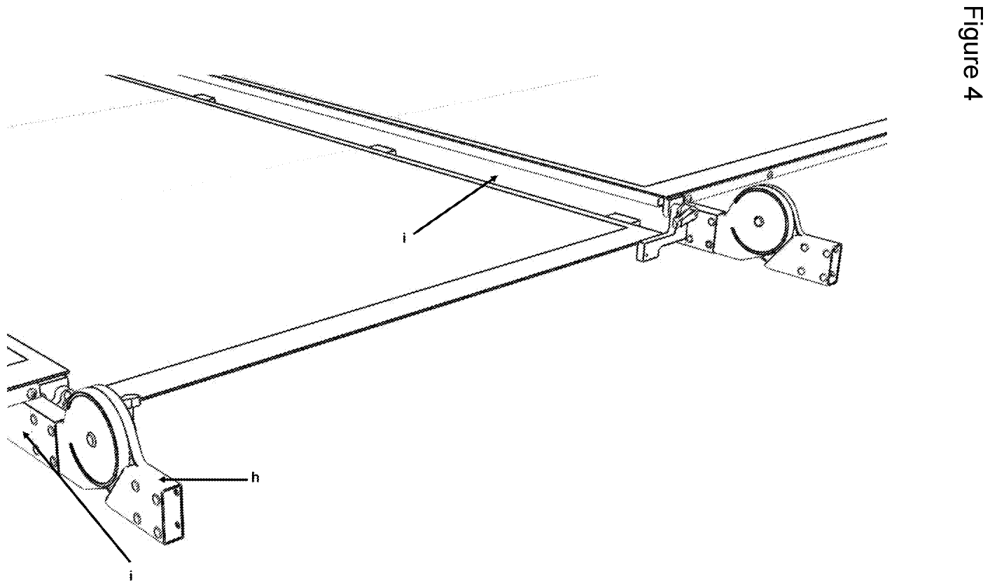

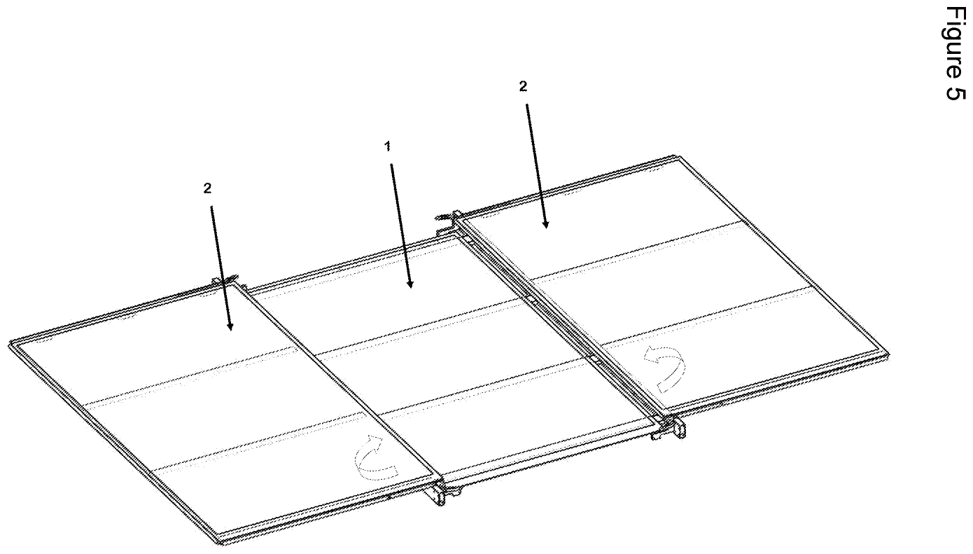

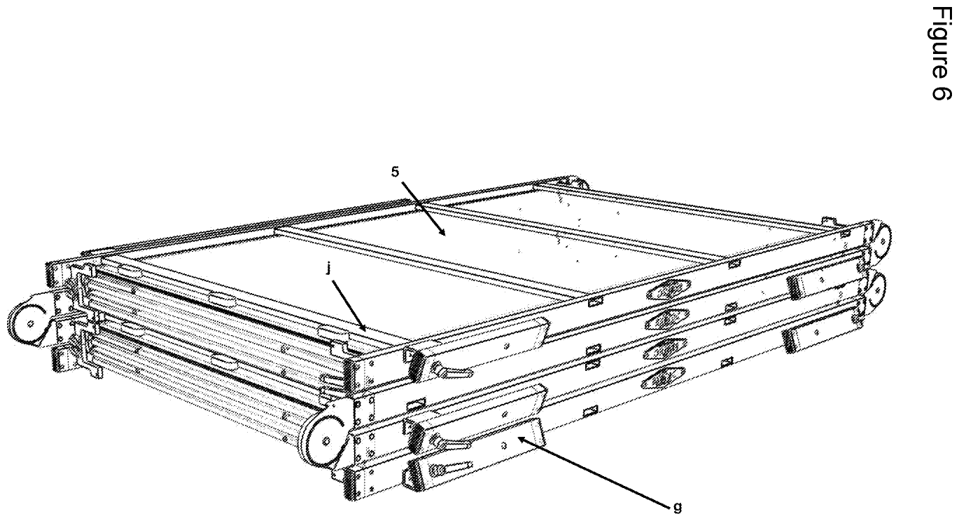

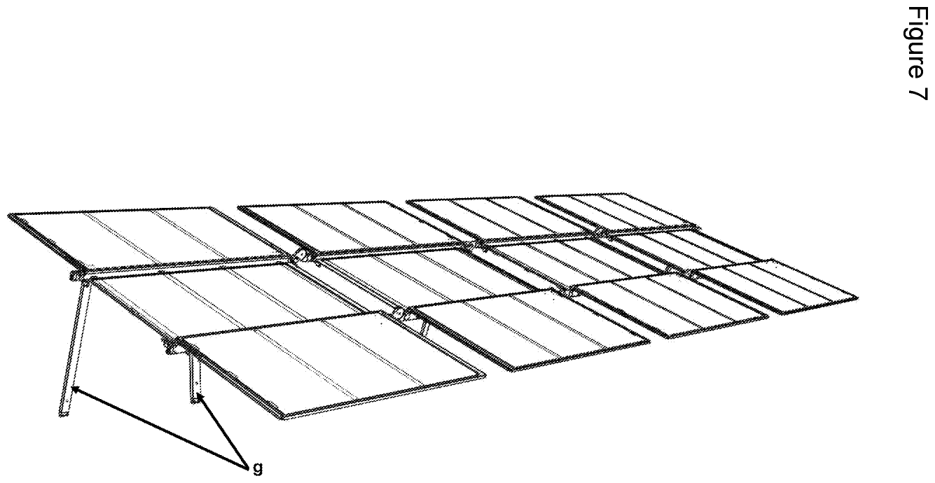

As shown in FIGS. 1-4, the present invention comprises:
1. Central frame (a) with a solar module (b) (FIG. 1);
2. Side Frame (c) equipped with a solar module (d) and hinges (e) (FIG. 2);
3. Four clamping levers (f) (FIG. 3)
4. Two or four hinges (h) attached to the ends of the long tubes (i) of the central frame (FIG. 4);
5. Complete Element with one central Frame (1) and two Side Frames (2) (FIGS. 5); and
6. Solar array consisting of one or more elements, each formed by a central frame (1) and two articulated side frames (2) and legs (g) (FIGS. 6, 7);

The two side frames (2) are hinged to the center frame (1) so that they can be rotated 180 degrees like the pages of a book. The hinges of the side frames (e) are attached to the central frame by means of clamping levers (f) that allow the hinges to be locked in the desired position. A suitable number of legs (g) are attached to each side of the central frame (1) in such a way that they can be rotated and locked in the desired position with clamping levers.

Two or four locking hinges (h) attached to the ends of the long tubes of the central frame (1) make it possible to connect several central frames (1) to form a chain of articulated elements, which can take on multiple geometries thanks to the locking hinges.

The present invention works in the following way:

The side frames, each equipped with a solar panel, are hinged to the center frame, which is also equipped with a solar panel, allowing the side frames to be set in the extended position when the solar array is to produce solar energy, or to be set in the closed position when the solar array is to be stored or moved to another location. The locking hinges that connect each of these groups of three frames form a chain of elements that can be deployed in an infinite number of positions and can be folded to make the solar array as compact as possible for easy storage or transport.

In one embodiment, the present invention can be made in the following way:

Build Side Frame (2) by assembling the solar panel (b) to part (c) using glue or screws, depending on the type of solar panel. Insert the hinges (e) into part (c) at the appropriate points and secure them with two screws (k) per hinge. Repeat on the other side frame.

Build Central Frame (1) by assembling the solar panel (b) to part (a) using glue or screws, depending on the type of solar panel. Assemble the two side frames (2) and Central Frame (1) by placing the hinges (e) in front of the holes (m) and (m′) provided in the central frame, insert the screw of the clamping lever through hole (m) or (m′) and screw it into the thread of the hinge (e) until it locks. Repeat the operation on the other three hinges. Use the hole (m) to fix the first side Frame (2) and the hole (m′) to fix the other side Frame (2), so that the two panels close on each other without colliding.

Insert the locking hinges (h) into the ends of the long tubes (i) of the center frame and secure them with screws or rivets, depending on the type of hinge.

Attach the swivel legs (g) to the threaded rod previously passed through one of the center frames (2) connecting tubes (j).

The legs can have multiple and varied lengths, depending on the height or operational configuration of the solar array. They are therefore considered an essential accessory for the proper use of the invention.

The invention can be completed with ballasting or anchoring elements, both of which are optional.

The segments formed by a central frame and two lateral frames (Tryptic) can be chained at will and without any intrinsic limitation to the system, thus allowing the pre-assembly of solar arrays of any size and that can take on any final geometry, thanks to the locking hinges that connect all the segments together. Use the self-locking hinges to link several complete Elements (5) together to form a chain.

The completed solar array of the present invention can be deployed and used in the following way:

The solar array will usually be delivered on a pallet, which can have up to ten solar arrays due to the compactness of this invention.

Due to its low weight, the solar array on top of the stack can be dropped by two people and transported to the deployment site with a hand truck. After turning the four legs of the first segment, the solar array can be placed on the ground and is ready for the deployment of the other segments. Unlock the two hinges connecting the first segment to the second one, then rotate the first segment to a position where the legs of the segment can be rotated, then unlock the hinges of the next segment and deploy it. Repeat this process on all segments.

When all segments are unfolded and resting on their legs, loosen the side frame clamping levers on the first segment, rotate the side frame until it locks and retighten both clamping levers to hold the side frame in the open position. Repeat the operation on all side frames of all segments of the solar array.

If necessary, secure the solar array to the ground with foundation screws or ballast with sandbags, water cans or cement blocks through the holes provided in the legs.

This invention can be equipped with photovoltaic solar panels, thermal collectors or any kind of panels that need to be operated in an extended position and stored in a compact position.

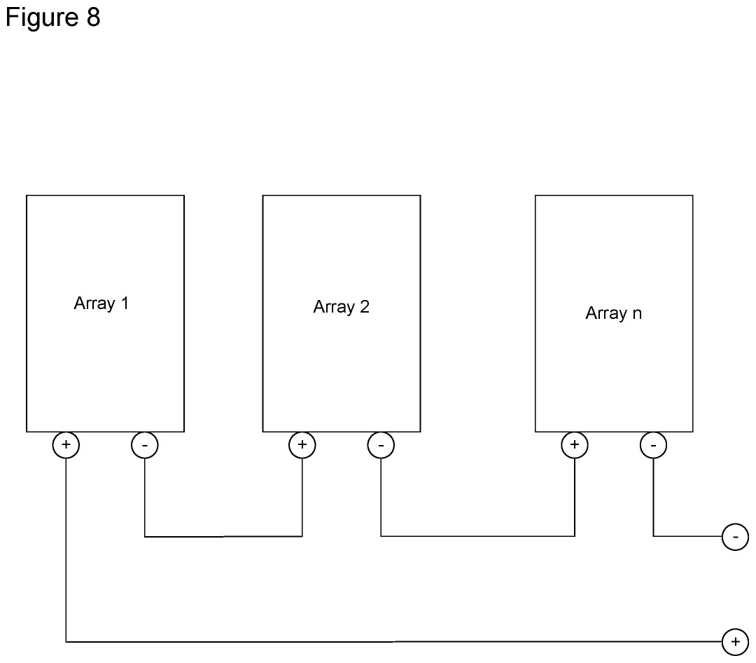

Further embodiments of the present invention are illustrated in FIGS. 8-12.

Individual solar panels can be connected in serial or in parallel. As known in the art, the typical solar panel produced a voltage of between 12 volt and 24 volts.

The output voltage of a solar panel array can be increased by electrically connecting the panels in serial. A serial connection results in the output voltage of the array being the total of the individual voltages of each panel in the array. Thus, the output voltage of two panels connected series would be between 24 and 48 volts. FIG. 8 illustrates a serial connection of solar Array 1 through n.

The power output of a solar panel is rated in watts. Power rating depends on the efficiency of the solar panel, the number of solar cells the panel contains and the type of solar panel. Power the produce of voltage time amperes. Thus, a 120-watt solar panel having a 12-volt output is expected to generate approximately 10 amperes when connected to a load.

In order to increase the power, and thus amperes, solar panels can be connected in parallel. Accordingly, two 120-watt solar panels connected in parallel are expected to produce approximately 240 watts of power and 20 amps at 12 volts.

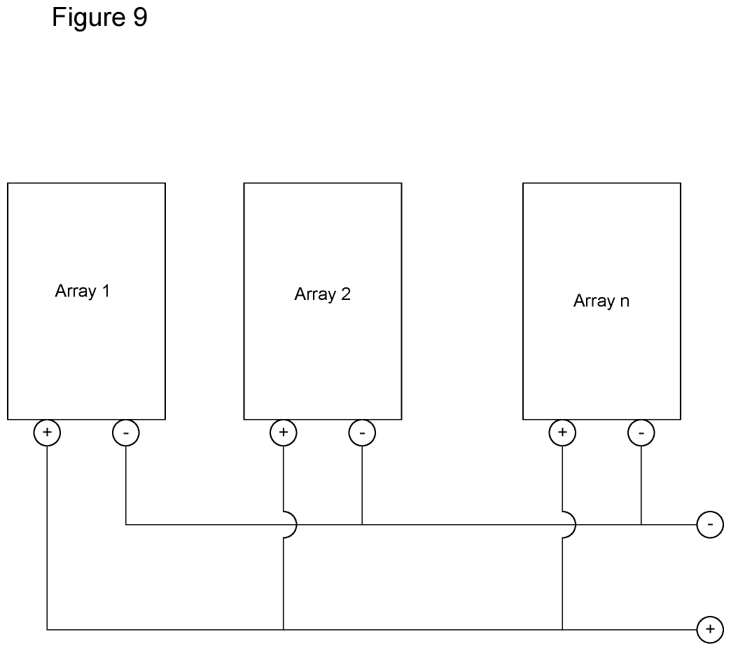

FIG. 9 illustrates a parallel connection of solar Array 1 through n.

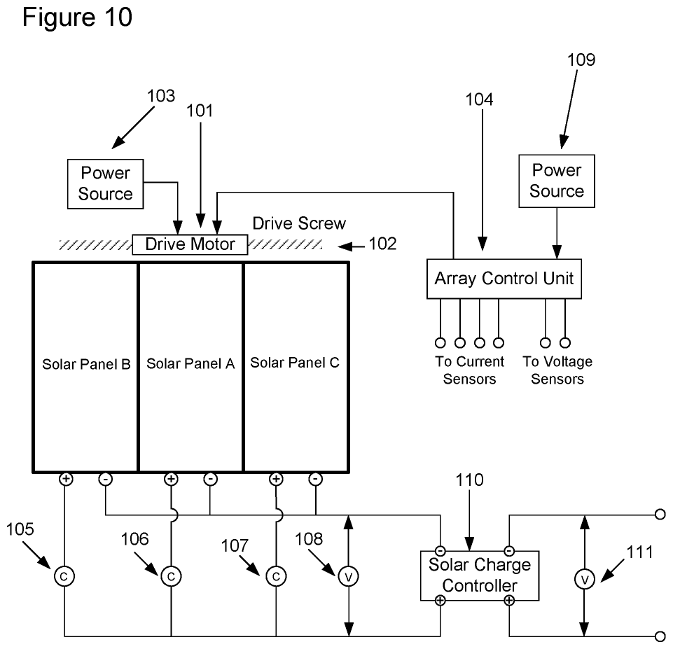

FIG. 10 illustrates a further embodiment of the present invention. In this embodiment, Solar Panels A, B and C correspond to solar panels 1, 2 and 3 shown in FIG. 5. Solar Panels B and C can be folded onto Solar Panel A by a Drive Motor 101 turning a Drive Screw 102. Drive Motor 101 is powered by a Power Source 103 and is controlled by an Array Control Unit 104.

A number of other devices can serve the purpose of Drive Screw 102, such as a rack and pinion drive system, a worm gear, a sprocket and chain, a linear actuator or any combination thereof.

As shown in FIG. 10, the solar array is connected in parallel as discussed above. The current from each of Solar Panels A-C can be measured by a plurality of current sensors 105-107 and the voltage can be measured by voltage sensor 108. Array Control Unit 104 is powered by a Power Supply 109 which can also be the same one used to power Drive Motor 101 or be a separate supply. Power for Drive Motor 101 and Array Control Unit 104 can be derived from the solar array as discussed below.

A Solar Charge Controller 110 is also provided in this embodiment of the present invention. Solar Charge Controller 110 prevents a connected battery from being overcharge by regulating and current from the solar array to the battery as will be discussed below.

The voltage at the output of Solar Charge Controller 110 is also sensed by a Voltage Sensor 110.

The Current Sensor 105 and Voltage Sensors 111 are supplied to Array Control Unit 104 as discussed below.

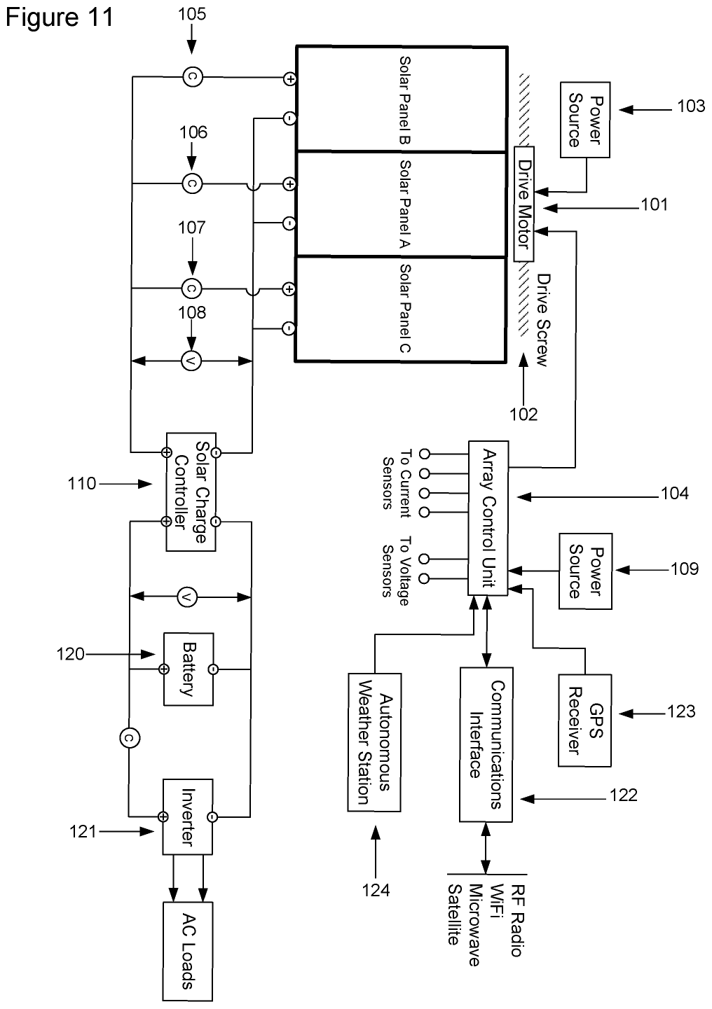

FIG. 11 illustrates a further embodiment of the present invention which expands on the embodiment shown in FIG. 10 and includes a Battery 120 connected in parallel with the output of Solar Charge Controller 110 and Inventor 121. Inventor 121 converts the direct current (DC) output from Solar Charger Control 110/Battery 120 combination to a usable alternating current (AC) power for powering AC loads.

The embodiment of the present invention illustrated in FIG. 11 also illustrates a Communications Interface 122. The purpose of this Interface is to allow remote status monitoring and control of the solar array using any one of a number of connection paths, such RF Radio, WiFi, Microwave, Satellites, etc.

A GPS Receiver 123 is connected to Array Control Unit 104. The GPS Receiver provides the Control Unit with an accurate GPS coordinate location of the Solar Array and an accurate time of day. Because the exact location of the sun can be determined at any time of the day for any location on Earth, Array Control Unit 104 can always maintain a fix on the sun and control Drive Motor 101 to adjust the lateral position of at least Solar Panels B and C, or in fact the entire array, to track the movement of the sun across the sky. Doing so will allow the Solar Panel to always be pointed in the best direction for maximum sunlight illuminations and maximum power production from the panels.

Array Control Unit 104 can also command Solar Panels B and C to close onto Solar Panel A at night or during periods in order to protect the panels from inadvertent hazards while the panels would not be producing energy in any event.

Also connected to Array Control Unit 104 is Autonomous Weather Station 124. The Weather Stations makes period observers of the weather environment around the Solar Array and provides that information to Array Control Unit 104. The Array Control Unit uses this information to determine if it need to take any defensive measure to protect the Solar Array.

In a large Solar Array field, where the need to protect the field would justify the expense, Autonomous Weather Station 124 could include Doppler radar. This is the technique used by many whether forecasting services to predict a hail storm. Dual-polarization radar technology, can distinguish hail, ice pellets and rain. Such technology can even determine hail size. Using this information, Array Control Unit 104 can be programed to command Drive Motor 101 to close Solar Panel B and C onto Panel A in order to protect them from hail damage.

Other severe weather events might also be cause for Array Control Unit 104 to command Drive Motor 101 to move the solar panels to a fetal or protective position. Providing protection against weather events, such as wind, hail, or snow results in lower replacement rate of the solar array resulting lower insurance cost and production interruptions. In addition, closing the panels in the presence of dust storms helps prevent the panels from being covered in dust, thereby reducing their ability to generate electrical energy. Accordingly, cleaning costs are lowered.

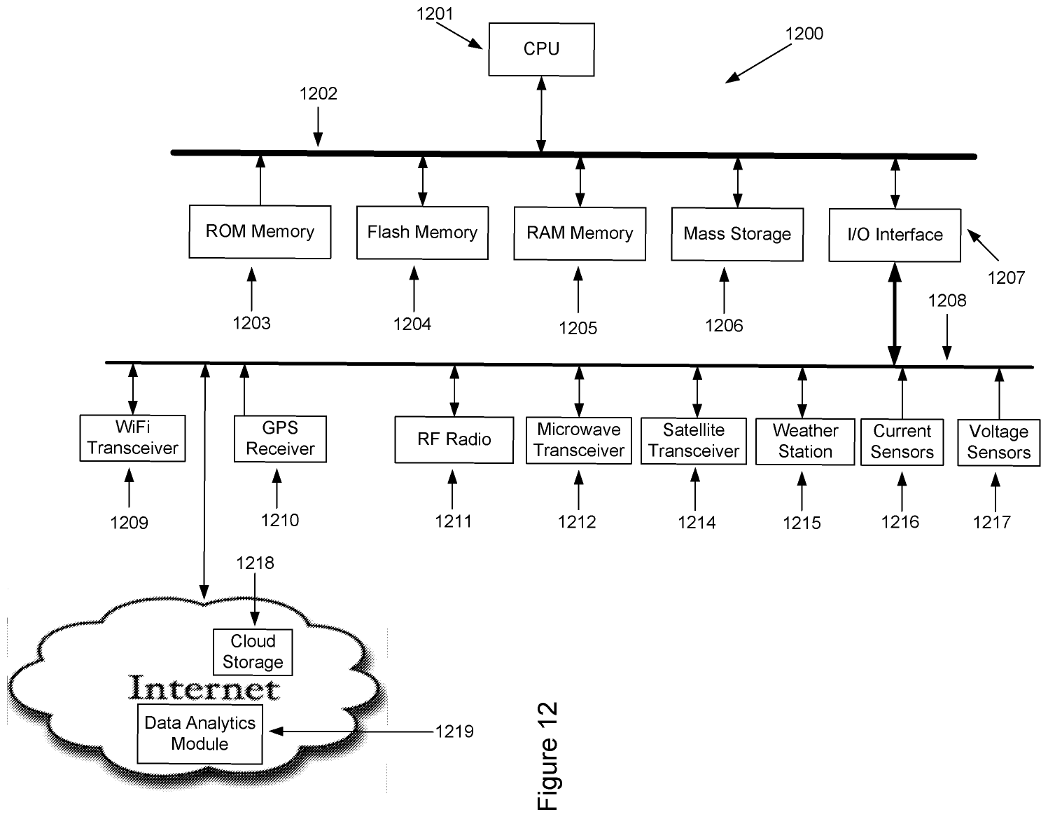

FIG. 12 is an overall block diagram of a one embodiment of the Array Control Unit 1200 according to present invention.

As shown in FIG. 12, the Control Unit includes Central Processing Unit (CPU) 1201 which is used to execute computer software instructions as is known in the art. CPU 1201 is coupled, via bus 1202, to ROM Memory 1203, Flash Memory 1204, RAM Memory 1205, Mass Storage 1206 and I/O Interface 1207.

ROM Memory 1203 and Flash Memory 1204 may be used to store computer software instructions for execution by CPU 1201.

RAM memory 1205 may also be used for storing computer software instructions, and especially for storing information that is only needed for a short period of time. Mass Storage 1206 is used for longer and larger data storage needs as may be required to be retain for data analysis over time.

I/O Interface 1207 allows the Control Unit to communicate via bus 1208 to other parts of the system, such as WiFi Transceiver 1209, GPS Receiver 1210, RF Radio 1211, Microwave Transceiver 1212, Satellite Transceiver 1214, Weather Station 1215, Current Sensors 1216 and Voltage Sensors 1217.

The number of other features might reside on the Internet. For example, Cloud Storage 1218 and a Data Analytics Module 1219 for analyzing system data over time.

By way of further explanation, the solar array of the present invention is a modular solar array that can accommodate several types of solar modules of different thickness, reusing a large number of shared parts between models. This set of shared parts is called the “base structure” and can be pre-assembled, stored and shipped as a kit independently of the solar panels they will receive.

Parts specific to the type of solar module being used are assembled separately as “side panels” and are also independent of the base structure for production, storage and shipping.

The base structure, side panels and options are combined in the final assembly phase, which also includes cable routing.

With reference again to the drawings, additional embodiments of the solar array of the present invention will be described.

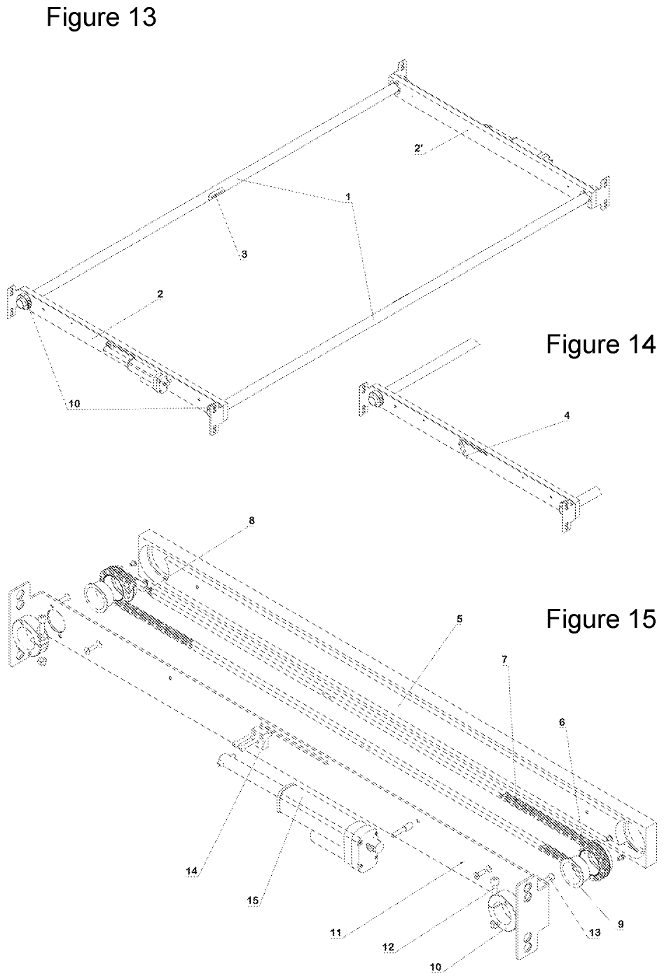

FIG. 13 depicts the basic structure which is formed by two Drivers 2 and 2′ and two tubes 1 which connect them to form a solid and robust assembly. Figure A also shows the cable glands 3 inserted in the tubes 1 in the openings provided for this purpose.

FIG. 14 depicts a manually operated driver with a quick screw handle 4.

FIG. 15 depicts Driver 2 in exploded view. Driver 2′ is identical but the components are assembled symmetrically to Driver 2 so as to form a mirror device between Drivers 2 and 2′.

Both Drivers are composed of a base plate 11, a housing 5 which has the function to protect the chain 7 and to allow a less frequent lubrication, as well as to be used as a guide. Clamping rings 10 are screwed on the base plate 11 by means of screws 13 and which, thanks to the screws 12, allow to clamp the tubes 1 and to make them integral with the base plate 11.

If a linear actuator is used, the system includes a connecting element 14 that allows the actuator 15 to transmit a linear motion to the chain 7.

The operating principle will now be described.

The purpose of the Drivers is to transform the linear movement imposed on the chain by the linear actuator or by a manual handle into a simultaneous rotation of the two sprockets 6 from 0° to 240°. The chain is equipped with a tensioner 8 which can be adjusted to ensure optimum tension throughout its service life.

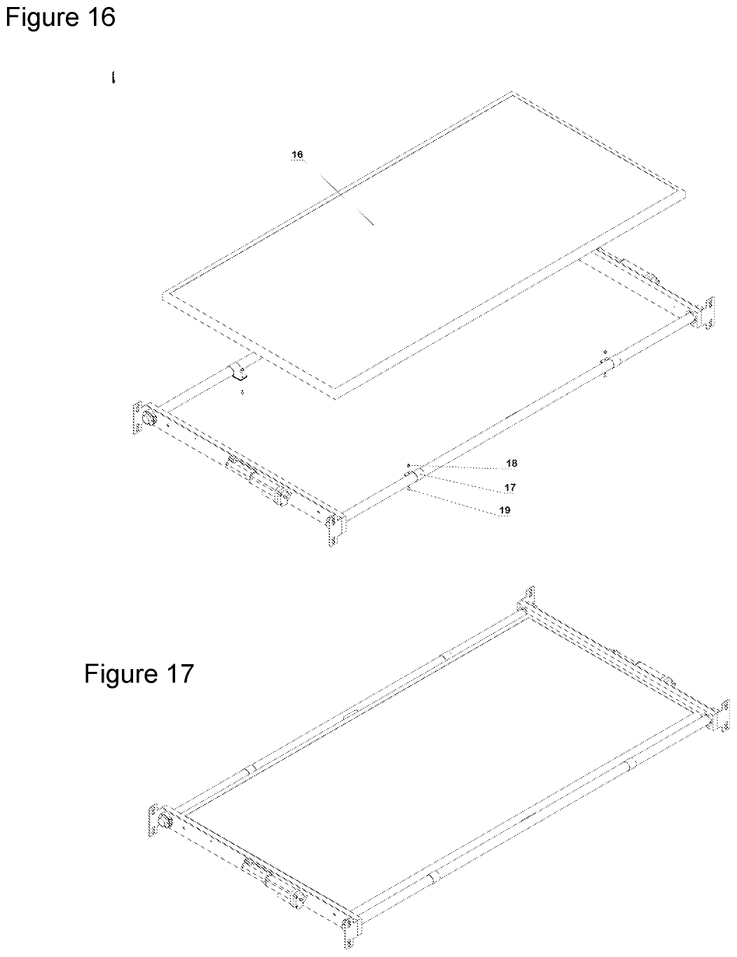

FIG. 16 depicts an exploded view of the assembled structure with the central solar module 16, its fixing clamps 17 and the screws 19 and nuts 18 that allow to assemble the solar module to the clamps and the tubes 1 in a single step.

FIG. 17 depicts a compacted view of the central structure assembled with the central module 16, ready to receive the side panels.

FIG. 18 depicts a base structure as depicted in FIGS. 16 and 17 as well as two solar panels attached to forks 20 with bolts 21. One of the panels is arranged above the base element and equipped with a protective shield 19, the other arranged below the base element without a protective shield. The forks 20 are fixed on the internal faces of the four sprockets 10 and are fixed by the screws 13 in order to make the forks 20 and the sprockets 10 integral. The assembly formed by all these elements assembled is called “segment”.

FIG. 19 depicts a segment of three complete solar modules in closed position.

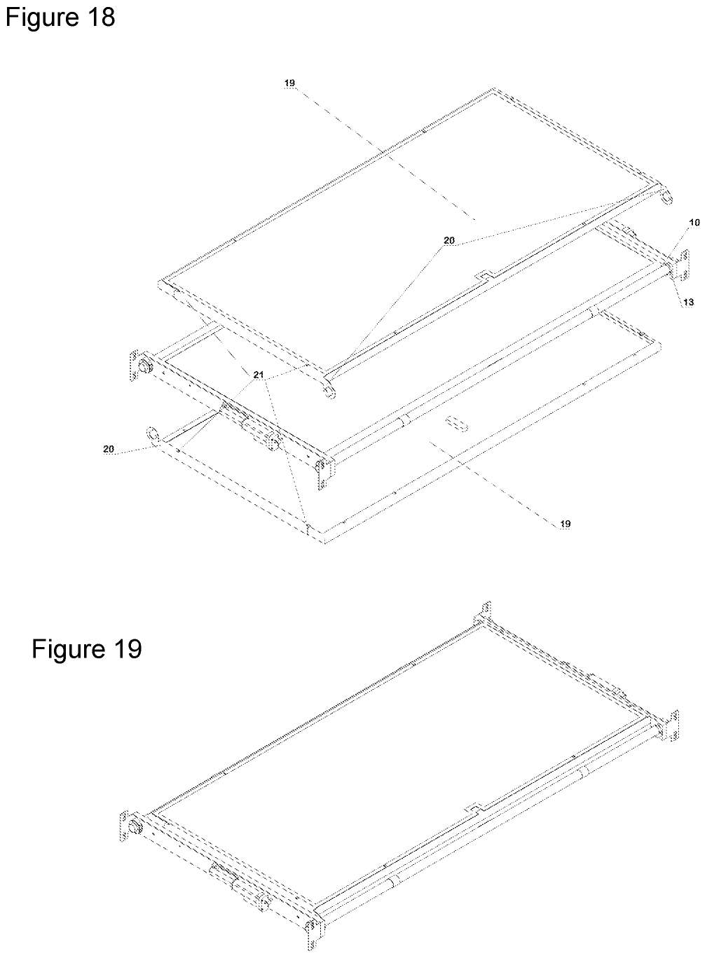

FIG. 20 depicts a lateral view of the closed segment (0°).

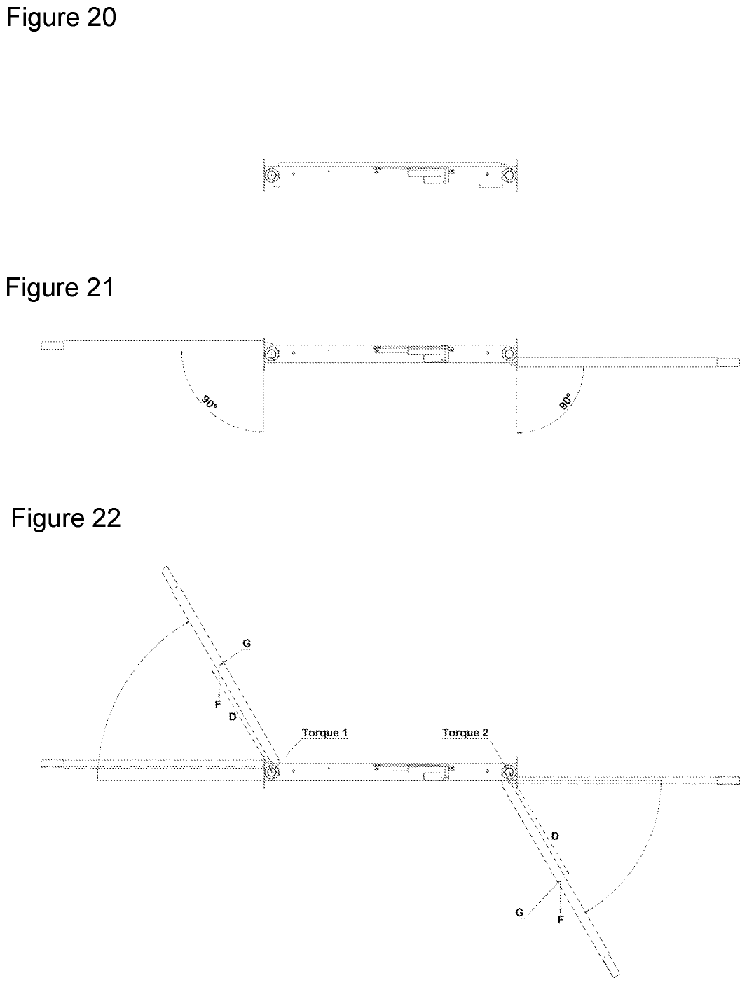

FIG. 21 depicts a side view of the segment in a flat position (180°)

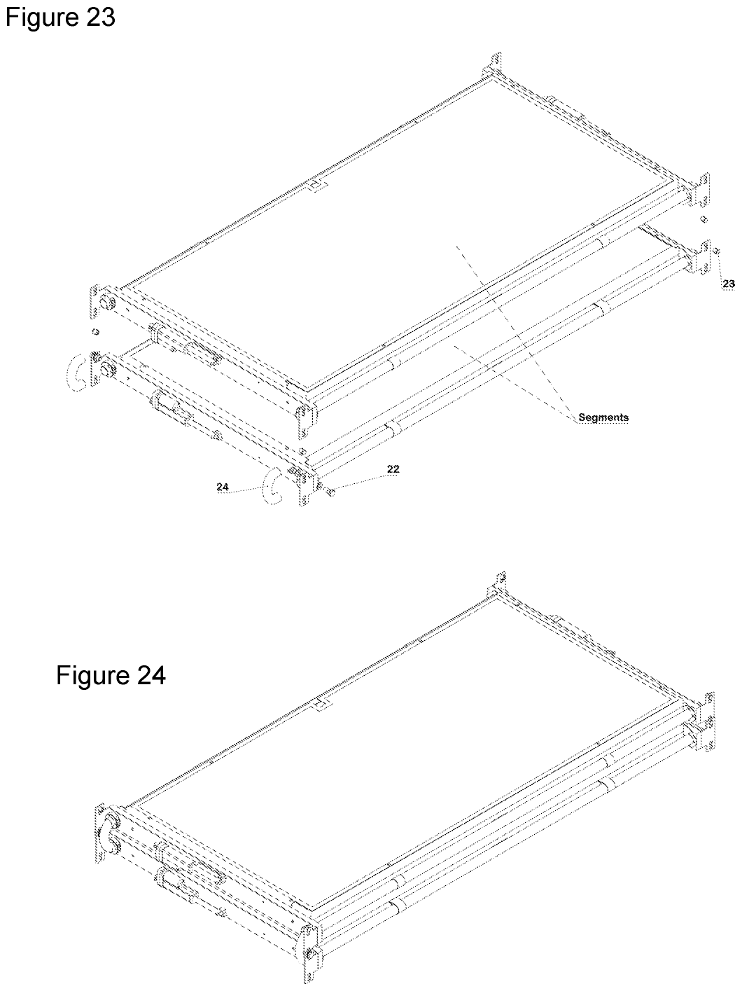

FIG. 22 depicts a side view of a segment at its maximum opening of 240° and provides indications to explain the dynamic balancing system by a simple formula.

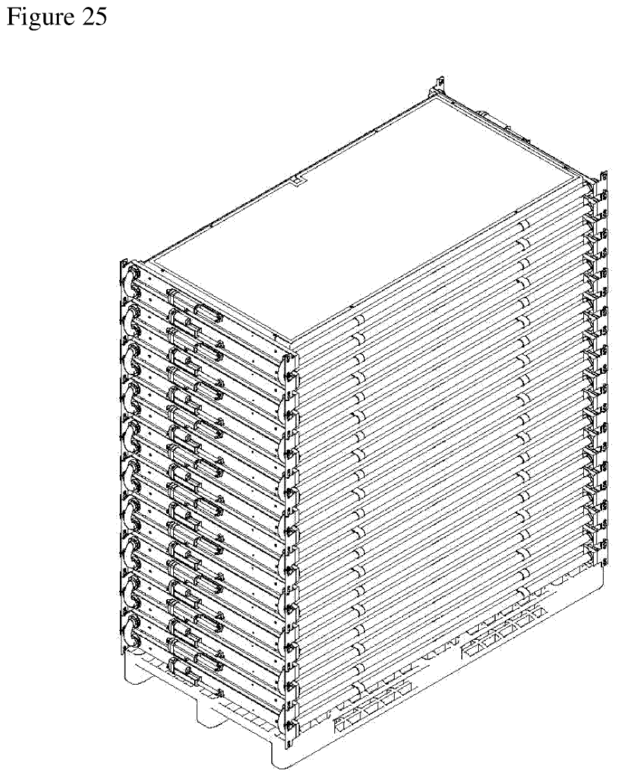

FIG. 23 depicts two segments in the assembly phase. The two segments are placed on top of each other, with the top module with its protective shield 19 facing up and the other segment with its protective shield 19 facing down. The two segments are connected by a bolt 22 inserted in the holes provided for this purpose, so as to obtain the pivoting of the two segments in relation to each other. Quick-clips 23 are inserted in the holes at the opposite end of the assembly formed by the two segments, so as to prevent the segments from pivoting and thus obtain a complete and compact solar array, ready to be stacked for storage or transport. Cable sleeves 24 are attached to the tubes 1 at their end near the pivot point. MC4 connectors are crimped onto the cables coming out of the end of the tubes at the other end of the segments.

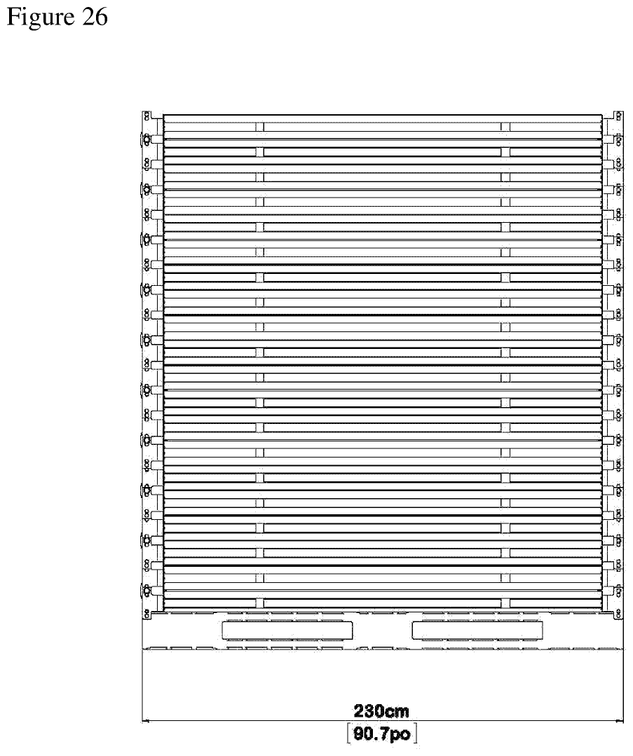

FIG. 24 depicts a complete solar array, including six deployable solar modules, fully wired and ready to use without the use of tools or electrical skills, with the cables all terminating in MC4 connectors assembled at the factory.

The cables being all hidden inside the Tubes 1 have an additional protection against UV rays and damages that can be caused by animals or bad weather. This feature is part of the self-defense philosophy which, together with the automatic closing features of the modules, characterizes this invention.

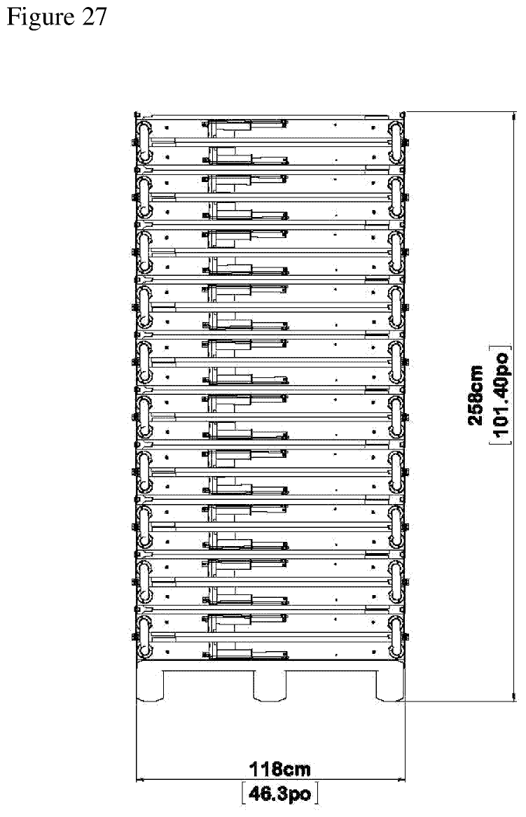

FIG. 25 depicts 10 solar arrays stacked on a pallet.

FIGS. 26 and 27 depict a complete pallet as well as its maximum dimensions allowing to load 10 of these pallets in a 40″ High Cube maritime container. The design of this invention, in particular its dimensioning, is the result of a backward path from the standard dimensions of maritime containers in order to obtain a solution optimized for the ISO Intermodal standard.

Dynamic balancing is achieved by the lateral solar panels making a circular movement around their pivot points which varies from 0° to 240°, in order to follow the path of the sun in an optimal way throughout the day or to be closed remotely or by a weather station in case of bad weather.

The respective masses of the two side modules generate respectively Torque 1 and Torque 2 at their pivot point which are identical for each module but have an opposite direction of rotation. This direction of rotation is always clockwise for one and counterclockwise for the other, and this is valid in all cases and at all angles of opening of the modules.

Torques 1 and 2 (Nm) are equal to:

$$\begin{matrix}Mass ( Kg ) at the center of gravity G of the side module \\ X \\ Gravitational force g ( 9.81 ms 2 ) \\ X \\ Cos α \\ X \\ D ( m )\end{matrix}$$

The sprockets, subjected to torques whose direction of rotation is always opposite, apply two antagonistic forces to the chain which annihilate each other. This makes it possible, among other things, to reduce the size of the linear actuators and their energy consumption, since the force required to actuate the chain is theoretically zero, except for friction and inertia

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A solar array system, said system comprising:
a plurality of foldable solar panels, wherein at least some of said plurality of solar panels can be folded on to others of said plurality of solar panels by a drive mechanism;
a drive motor for said drive mechanism; and
a control unit controlling said drive motor in response to at least one environmental condition.
